(19) United States
(12) Patent Application Publication
(10) Pub. No.: US 2024/0319576 A1
(43) Pub. Date: Sep. 26, 2024

(54) CAMERA MODULE

(71) Applicant: SAMSUNG ELECTRO-MECHANICS CO., LTD., Suwon-si (KR)

(72) Inventor: Viatcheslav SMIRNOV, Suwon-si (KR)

(73) Assignee: SAMSUNG ELECTRO-MECHANICS CO., LTD., Suwon-si (KR)

(21) Appl. No.: 18/538,400

(22) Filed: Dec. 13, 2023

(30) Foreign Application Priority Data
Mar. 21, 2023 (KR) 10-2023-0036418

(51) Int. Cl. G03B 30/00; H04N 23/55; H04N 23/57

(52) U.S. Cl. CPC G03B 30/00; H04N 23/55; H04N 23/57

(57) ABSTRACT

A camera module is provided. The camera module includes a lens barrel including a plurality of lenses provided therein in an optical axis direction, a holder coupled to the lens barrel, a sensor substrate fixed to the holder, and including an image sensor, a housing to which the holder is coupled, and a main substrate provided in the housing.

### CROSS-REFERENCE TO RELATED APPLICATIONS

This application claims the benefit under 35 USC § 119(a) of Korean Patent Application No. 10-2023-0036418, filed on Mar. 21, 2023, in the Korean Intellectual Property Office, the entire disclosure of which is incorporated herein by reference for all purposes.

### BACKGROUND

### 1. Field

The following description relates to a camera module.

### 2. Description of Related Art

Surveillance cameras, such as Closed-circuit televisions (CCTVs), are an example of a product in which camera images are deteriorated due to temperature changes or the surrounding environment. However, recently, as the demand for in-vehicle cameras has increased, and the fields of application thereof have also expanded, a method for resolving the phenomenon of image deterioration due to the surrounding environment has been desired.

Recently, vehicles have been equipped with many cameras for advanced driver assistance systems (ASAS), such as surround view monitoring (SVM) cameras, as well as rearview cameras, and in the future, various cameras having various different operations are expected to be installed in many vehicles.

Additionally, the related art camera may additionally include a heater, or may include a heat-retaining structure to prevent the deterioration of images that are captured in cameras that are operated in low temperatures, such as in winter.

However, with the recent increase in the demand for automotive cameras and the demand for the miniaturization of automotive cameras, a problem that camera performance may be easily deteriorated due to external environmental factors has emerged.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a lens barrel comprising a plurality of lenses provided therein in an optical axis direction; a holder coupled to the lens barrel; a sensor substrate fixed to the holder, and including an image sensor; a housing to which the holder is coupled; and a main substrate provided in the housing.

The lens barrel may be coupled to an inner surface of the holder, and an outer surface of the holder may be coupled to the housing.

The sensor substrate may be coupled to a lower end portion of the holder in the optical axis direction.

The sensor substrate may be coupled to the holder by bonding with an adhesive material.

An adhesive application line that couples the holder to the sensor substrate may have a round shape.

An adhesive application line that couples the holder to the sensor substrate may have a circular shape.

The sensor substrate may have a substantially quadrangular shape.

A center of the image sensor may substantially coincide with a center of the adhesive application line.

The housing may include an upper housing and a lower housing that are coupled to each other to form an internal space, and the housing is configured to accommodate the holder and the image sensor in the internal space.

The main substrate may be connected to the sensor substrate, and is provided in the lower housing.

The holder may be formed of a material having a coefficient of thermal expansion (CTE) that is less than a CTE of the lens barrel or a CTE of the housing.

The holder may have a substantially cylindrical shape.

In a general aspect, a camera module includes a lens barrel comprising a plurality of lenses provided therein in an optical axis direction; a holder coupled to the lens barrel; a sensor substrate, fixed to a lower end portion of the holder in the optical axis direction by bonding with an adhesive, and including an image sensor; and a housing coupled to the holder, wherein an adhesive application line to couple the holder to the sensor substrate has a circular shape.

Optical axes of the plurality of lenses provided in the lens barrel may substantially coincide with a center of the adhesive application line.

The holder may have a lower end portion having a substantially cylindrical shape.

In a general aspect, a camera module includes a lens barrel comprising a plurality of lens; a housing; a holder comprising a main frame coupled to the housing, an auxiliary frame coupled to the lens barrel, and a bridge configured to connect the main frame and the auxiliary frame; a sensor substrate fixed to a lower end of the holder; and an adhesive application line, provided in an aspherical shape, and configured to connect the sensor substrate to the holder.

Other features and aspects will be apparent from the following detailed description, the drawings, and the claims.

### BRIEF DESCRIPTION OF DRAWINGS

FIG. 1 illustrates a combined perspective view of an example camera module, in accordance with one or more embodiments.

FIG. 2 illustrates an exploded perspective view of an example camera module, in accordance with one or more embodiments.

FIG. 3 illustrates a combined cross-sectional view of the example camera module, in accordance with one or more embodiments.

FIG. 4 illustrates a combined perspective view of an example lens module, in accordance with one or more embodiments.

FIG. 5 illustrates an exploded perspective view of an example lens module, in accordance with one or more embodiments.

FIG. 6 illustrates a combined cross-sectional view of an example lens module, in accordance with one or more embodiments.

FIG. 7 and FIG. 8 are combined cross-sectional views of an example lens module, in accordance with one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning, e.g., the phrasing “in one example” has a same meaning as “in one embodiment”, and “one or more examples” has a same meaning as “in one or more embodiments.”

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

One or more examples may provide a camera module in which deterioration of a camera is reduced, without changing the appearance of the camera.

One or more examples may provide a camera module which may be easily assembled.

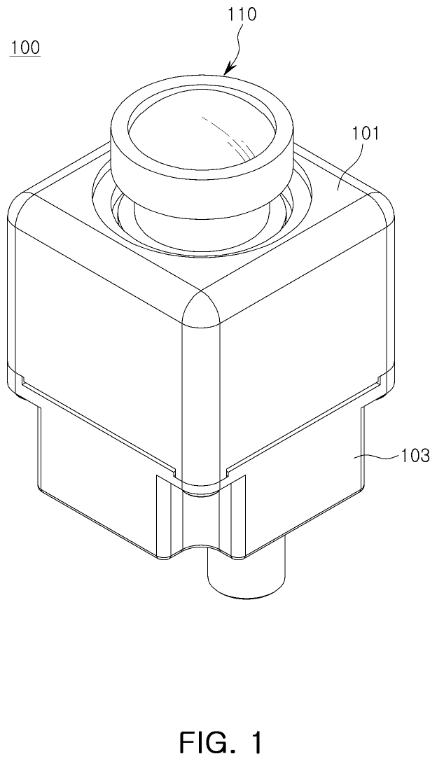

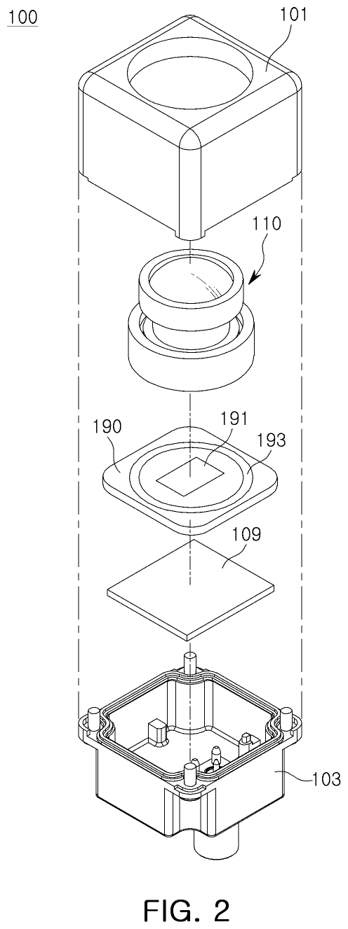

FIG. 1 illustrates a combined perspective view of an example camera module, in accordance with one or more embodiments, and FIG. 2 illustrates an exploded perspective view of an example camera module, in accordance with one or more embodiments.

Referring to FIGS. 1 and 2, an example camera module 100, in accordance with one or more embodiments includes a housing, which includes an upper housing 101 and a lower housing 103, a lens module 110 provided in an internal space of the housing which is formed by combining the upper housing 101 and the lower housing 102, and a sensor substrate 190, which is connected to the lens module 110 by a power connection line (not shown).

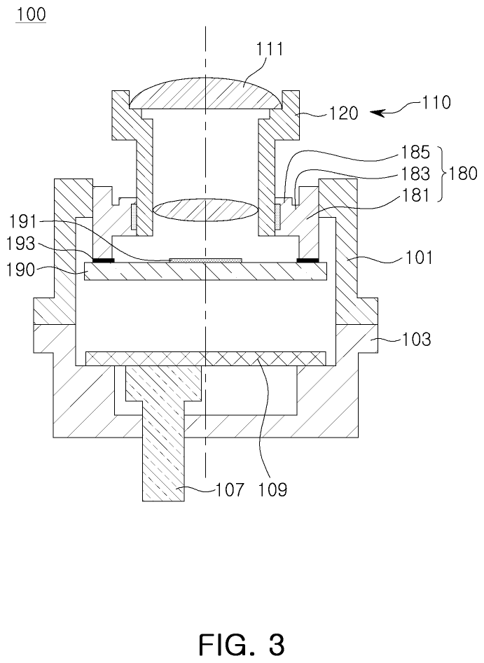

Additionally, in an example, a cover glass 111 (FIG. 3) may be provided at an upper end of the lens module 110, and a sealing member (not shown) formed of a material, such as, but not limited to, silicon or rubber, may be provided between the cover glass 111 and the lens module 110 to enhance sealing power. The cover glass 111 may be firmly coupled to the lens module 110 by an additional member (not shown) screwed into the lens module 110.

Additionally, a sealing member (not shown) formed of a material, such as, but not limited to, silicon or rubber, may be interposed between the lens module 110 and the upper housing 101 to enhance sealing power.

Referring to FIGS. 2 and 3, in an example, a connector 107 may be provided at a lower end of the lower housing 103 for power connection or control connection. Additionally, a main substrate 109 may be connected to the sensor substrate 190 provided in the lens module 110, and the sensor substrate 190 may be electrically or controllably connected to the main substrate 109.

In an example, the lens module 110 may have a substantially cylindrical shape. In an example both the lens barrel 120 and the holder 180 may have a substantially cylindrical shape, and the lens barrel 120 may be inserted into the holder 180. The lens barrel 120 may be fixed to the holder 180 in various manners, such as, but not limited to, bonding using an adhesive or screw coupling.

In an example, the housings 101 and 103 may have a substantially rectangular box shape. The upper housing 101 has an opening into which the lens barrel 120 and the holder 180 may be inserted. The holder 180 may be inserted into and fixed to the opening of the upper housing 101. The holder 180 may be fixed to the upper housing 101 in various manners, such as, but not limited to, bonding using an adhesive or screw coupling.

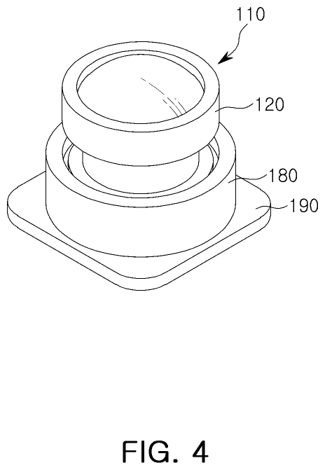

FIG. 3 illustrates a combined cross-sectional view of an example embodiment, and FIG. 4 illustrates a combined perspective view of an example lens module, in accordance with one or more embodiments.

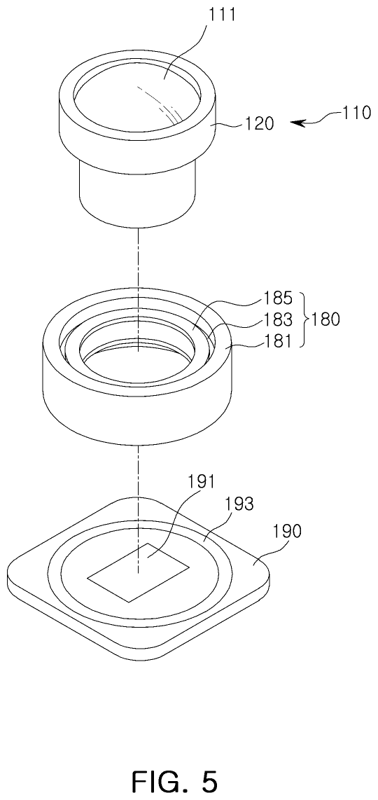

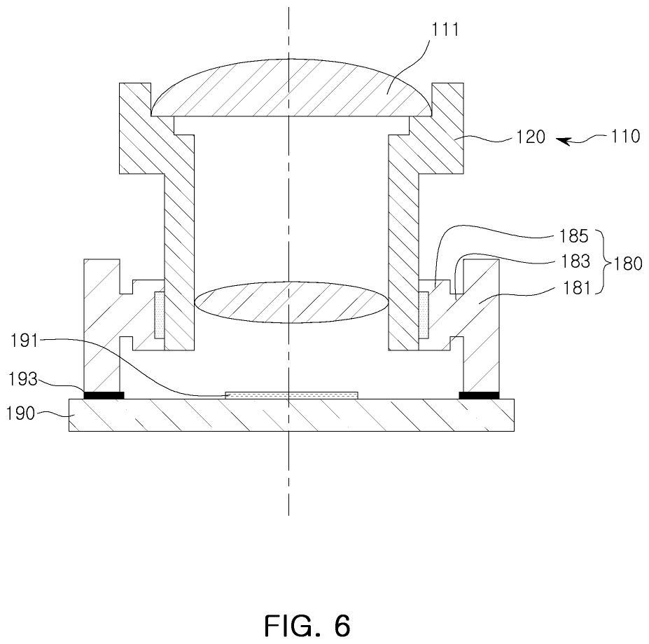

Referring to FIGS. 3 to 6, the example lens module 110 includes the lens barrel 120, the holder 180, and the sensor substrate 190.

The lens barrel 120 includes at least one lens stacked therein, and the cover glass 111 may be coupled to an upper end thereof. An additional member (not shown) may be screwed to the upper end portion of the lens barrel 120 to fix the cover glass 111.

The lens barrel 120 may have an internal space into which one or more lenses are inserted in a substantially cylindrical shape. Additionally, the top and bottom of the lens barrel 120 may be open, and the cover glass 111 exposed to the outside may be provided on the top, and lenses sequentially stacked in an optical axis direction may be disposed in the internal space.

Additionally, the lens barrel 120 may be formed, as only examples, of plastic, aluminum (AL) having good workability, or aluminum alloy (AL alloy). That is, in an example, the lens barrel 120 may be formed of a non-metal material, such as plastic, in addition to a metal material.

In an example, the housings, that is, the upper and lower housings 101 and 103, may be formed of plastic, aluminum (AL) having good workability, or aluminum alloy (AL alloy). That is, the housings 101 and 103 may be formed of a non-metal material, such as plastic in addition to a metal material.

Additionally, the lens barrel 120 and the housings 101 and 103 may be formed of the same material or different materials.

The holder 180 may be coupled to the outer surface of the lens barrel 120 by bonding using an adhesive or screw coupling. For screw coupling, the lens barrel 120 and the holder 180 are provided with threads so that they may be screwed together.

Additionally, the holder 180 may be formed of various materials, such as, but not limited to, plastic, metal, and alloy, and may be formed of a material having a relatively small coefficient of thermal expansion (CTE), compared to a coefficient of thermal expansion of the lens barrel 120 and a coefficient of thermal expansion of the upper housing 101.

The holder 180 may have a substantially cylindrical shape, and the cylindrical lens barrel 120 may be fixed to an inner surface thereof, and a square box-shaped upper housing 101 is coupled to an outer surface thereof. Additionally, since the holder 180 may be cylindrical, the upper housing 101 may have a circular opening to which the holder 180 may be fixed.

The holder 180 may be coupled to the lens barrel 120 by bonding using an adhesive, or may be screw-coupled. Similarly, the holder 180 may be coupled to the upper housing 101 by bonding using an adhesive or may be screw-coupled.

The holder 180 may include a cylindrical main frame 181 coupled to the upper housing 101, an auxiliary frame 185 coupled to the lens barrel 120, a bridge 183 interconnecting the main frame 181 to the auxiliary frame 185. In an example, the auxiliary frame 185 may have a structure extending upwardly in the optical axis direction from an inner end portion of the bridge 183.

The sensor substrate 190 may be coupled to a lower end portion of the holder 180 in the optical axis direction. The sensor substrate 190 may sense light incident on a lens provided in the lens barrel 120 as an electrical image. An image sensor 191 is provided on the sensor substrate 190.

The sensor substrate 190 may be coupled to the holder 180 by bonding using an adhesive. The sensor substrate 190 may be coupled to the lower end portion of the holder 180 in the optical axis direction. Additionally, an adhesive application line 193 that couples the holder 180 to the sensor substrate 190 may be provided in a round shape. More specifically, the adhesive application line 193 that couples the holder 180 to the sensor substrate 190 may be provided in a circular shape. In an example, the adhesive application line 193 that couples the holder 180 to the sensor substrate 190 may be provided in an aspherical shape.

Additionally, in an example, the center of the quadrangular image sensor 191 mounted on the sensor substrate 190 may substantially match the center of the circular adhesive application line 193.

In an example, the sensor substrate 190 may have a substantially quadrangular shape.

In an example, the vehicle camera module 100 may be provided to be exposed to the outside of a vehicle or the like, and thus, camera performance may be deteriorated according to extreme external environments.

Specifically, since the lens barrel 120 provided with the cover glass 111 is exposed to the outside, the lens barrel 120 may be easily exposed to high and low temperature external environments. Additionally, the upper housing 101 mounted on the lens barrel 120 is typically buried inside a vehicle or the like, and thus, is not directly exposed to the outside. Accordingly, when the lens barrel 120 and the upper housing 101 are directly coupled to each other, mutual distortion or twisting may occur because the thermal expansion of the parts takes place differently depending on a difference in environmental conditions applied to these members. Accordingly, when the sensor substrate is fixed to the upper housing 101, the optical axis of the lens barrel 120 and the center of the sensor substrate may be distorted.

Accordingly, in the one or more examples, the problem may be minimized by adding the holder member 180 between the lens barrel 120 and the upper housing 101 and the sensor substrate 190 is provided in the holder, rather than a structure in which the lens barrel 120 is directly coupled to the upper housing 101. Furthermore, the holder 180 may be formed of various materials, such as, but not limited to, plastic, metal, and alloy, and may be formed of a material having relatively low CTE, compared with the lens barrel 120 and the upper housing 101, thereby minimizing a change in shape of members according to environmental changes.

Additionally, the sensor substrate 190 may be coupled to the holder 180 by bonding using an adhesive. Additionally, the adhesive application line 193 that couples the holder 180 to the sensor substrate 190 may have a round shape. More specifically, the adhesive application line 193 that couples the holder 180 to the sensor substrate 190 may have a circular shape. As such, even though the image sensor 191 has a square shape, the adhesive application line 193 has a round shape corresponding to the shape of the holder 180, so that even if an external force is applied to the sensor substrate 190, warpage distortion of the sensor substrate 190 may be minimized.

The holder 180 may be fixedly coupled to an outer surface of the lens barrel 120. As described above, the holder 180 may be screwed to the lens barrel 120 or fixed by bonding using an adhesive. For screw coupling, the lens barrel 120 and the holder 180 are provided with screw threads so that they may be screwed together.

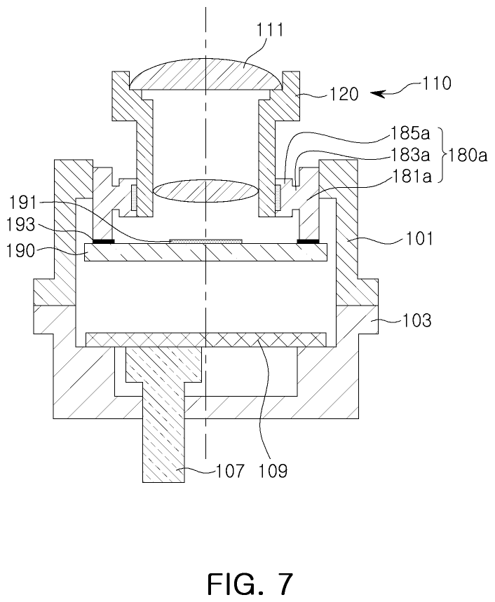

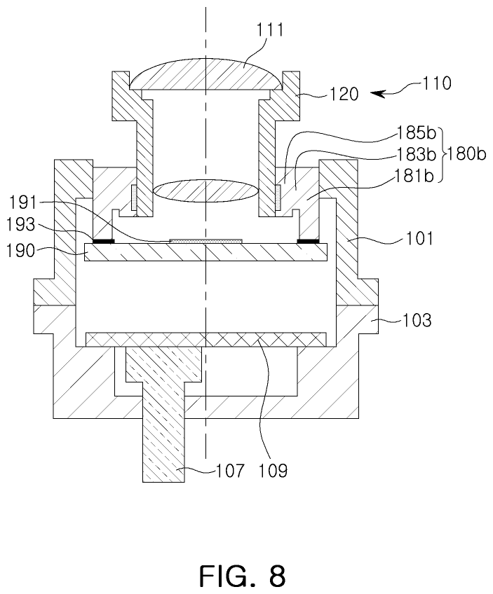

FIGS. 7 and 8 are combined cross-sectional views of an example lens module, in accordance with one or more embodiments.

Referring to FIG. 7, in the example lens module, all other components are the same as described above, and only the structure of a holder 180a is different from the description of the holder 180 above, and thus, the description given above with reference to FIGS. 1 to 6 is applied to the other components and structures.

The holder 180a may include a cylindrical main frame 181a coupled to the upper housing 101, an auxiliary frame 185a coupled to the lens barrel 120, and a bridge 183a interconnecting the main frame 181a to the auxiliary frame 185a. In an example, the auxiliary frame 185a may have a structure that extends from an inner end portion of the bridge 183a in both an upward direction and a downward direction in the optical axis direction.

Referring to FIG. 8, in the modified example of the lens module, all other components are the same and only the structure of a holder 180b is different, and thus, the description given above with reference to FIGS. 1 to 6 is applied to the other components and structures.

The holder 180b may include a cylindrical main frame 181b coupled to the upper housing 101, an auxiliary frame 185b coupled to the lens barrel 120, and a bridge 183b interconnecting the main frame 181b to the auxiliary frame 185b. In an example, the auxiliary frame 185b may have a structure that extends from an inner end portion of the bridge 183b in a downward direction in the optical axis direction.

According to the one or more examples, by adding a simple structure to the camera module, the camera module in which performance degradation is minimized due to a small change in shape and size may be provided.

Additionally, the one or more examples simplify manufacturing and facilitates assembly by adding a simple structure between the lens barrel and the housing.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A camera module, comprising:
a lens barrel comprising a plurality of lenses provided therein in an optical axis direction;
a holder coupled to the lens barrel;
a sensor substrate fixed to the holder, and including an image sensor;
a housing to which the holder is coupled; and
a main substrate provided in the housing.

2. The camera module of claim 1, wherein:
the lens barrel is coupled to an inner surface of the holder, and
an outer surface of the holder is coupled to the housing.

3. The camera module of claim 1, wherein the sensor substrate is coupled to a lower end portion of the holder in the optical axis direction.

4. The camera module of claim 3, wherein the sensor substrate is coupled to the holder by bonding with an adhesive material.

5. The camera module of claim 4, wherein an adhesive application line that couples the holder to the sensor substrate has a round shape.

6. The camera module of claim 4, wherein an adhesive application line that couples the holder to the sensor substrate has a circular shape.

7. The camera module of claim 6, wherein the sensor substrate has a substantially quadrangular shape.

8. The camera module of claim 7, wherein a center of the image sensor substantially coincides with a center of the adhesive application line.

9. The camera module of claim 1, wherein the housing comprises an upper housing and a lower housing that are coupled to each other to form an internal space, and the housing is configured to accommodate the holder and the image sensor in the internal space.

10. The camera module of claim 9, wherein the main substrate is connected to the sensor substrate, and is provided in the lower housing.

11. The camera module of claim 1, wherein the holder is formed of a material having a coefficient of thermal expansion (CTE) that is less than a CTE of the lens barrel or a CTE of the housing.

12. The camera module of claim 1, wherein the holder has a substantially cylindrical shape.

13. A camera module, comprising:
a lens barrel comprising a plurality of lenses provided therein in an optical axis direction;
a holder coupled to the lens barrel;
a sensor substrate, fixed to a lower end portion of the holder in the optical axis direction by bonding with an adhesive, and including an image sensor; and
a housing coupled to the holder,
wherein an adhesive application line to couple the holder to the sensor substrate has a circular shape.

14. The camera module of claim 13, wherein optical axes of the plurality of lenses provided in the lens barrel substantially coincide with a center of the adhesive application line.

15. The camera module of claim 14, wherein the holder has a lower end portion having a substantially cylindrical shape.

16. A camera module, comprising:
a lens barrel comprising a plurality of lens;
a housing;
a holder comprising a main frame coupled to the housing, an auxiliary frame coupled to the lens barrel, and a bridge configured to connect the main frame and the auxiliary frame;
a sensor substrate fixed to a lower end of the holder; and
an adhesive application line, provided in an aspherical shape, and configured to connect the sensor substrate to the holder.
